(19) United States
(12) Patent Application Publication
(10) Pub. No.: US 2005/0160308 A1
(43) Pub. Date: Jul. 21, 2005

(54) Failure recovery for digital video recorders

(75) Inventors: Albert F. Elcock, Havertown, PS (US); William J. Garrison, Warminster, PA (US)

Correspondence Address: Lipsitz & McAllister, LLC, 755 MAIN STREET, MONROE, CT, 06468, US

(73) Assignee: General Instrument Corporation, Horsham, PA (US)

(21) Appl. No.: 10/754,293

(22) Filed: Jan. 9, 2004

(51) Int. Cl. G06F 11/00

(52) U.S. Cl. 714/5

(57) ABSTRACT

A method for DVR (digital video recorder) recovery from interruptions is described. Interruptions include power failures, primary storage device failure, Emergency Alert broadcasts, loss of signal (LOS), etc. Upon detecting that an interruption has occurred, the DVR determines the duration of the interruption and consults a saved “journal” of DVR operations to determine what it was doing when the interruption occurred. If a program that was being recorded prior to the interruption is still running when the interruption ends, recording is resumed. If the interruption is long, then the DVR searches an electronic program guide to see if the program is available for re-recording at a later time. If so, it schedules re-recording at that time. Recovery methods for insufficient primary storage space are also described.

### TECHNICAL FIELD OF THE INVENTION

The present invention relates generally to digital video recording, and more particularly to direct video recording to a digital storage medium such as a hard disk drive.

### BACKGROUND OF THE INVENTION

Recent advances in video compression and encoding technology have made low-cost digital video recording practical for consumer products. Over the last decade, digital video recording products in the form of DVD (Digital Versatile Disk) recorders and direct-to-disk recorders have gradually been making progress against older analog VCRs (Video Cassette Recorders) and are making a significant showing in the video marketplace. Once reserved exclusively for high-cost, high-end broadcast applications (e.g., instant replay), direct-to-disk digital video recording is now widely available to consumers in the form of digital video recorder (DVR) technology.

Perhaps one of the most significant advantages of digital disk recording over tape recording techniques is the inherent random-access nature of disk recording as compared to the serial nature of tape recording. Other advantages of digital disk recording are that its digital nature effectively eliminates degradation of the recording with repeated playback and that hard disk drive density permits much greater storage capacity than conventional videocassettes.

One particular type of DVR is known as a Personal Video Recorder (PVR). PVRs have taken great advantage of the characteristics of digital video recording as well as recent advantages in networking and broadcast video technologies to provide a wide variety of highly desirable features such as Electronic Program Guides (EPG), time shifting, commercial skipping, etc. It is not unusual today to find PVRs capable of storing over 80 hours of digital video.

Personal video recorders (PVR) are essentially direct-to-disk digital video recording devices that employ a hard disk drive (HDD) as a primary storage medium. These devices may be standalone recording devices analogous to VCRs (e.g., TiVo®, a trademark of TiVo, Inc. of Alviso, Calif.), or embedded PVRs built into set-top boxes (STBs) for receiving cable and/or satellite television broadcasts. Advances in low-cost, high-density hard disk drives and video compression technology have combined to make PVRs both feature-rich and inexpensive. Typically, PVR technology is combined with a subscription EPG (Electronic Program Guide) service to greatly enhance a user's control over what will be recorded and when it will be viewed. Hereinafter, the term DVR is used as the generic description of digital video recording devices, and is intended to include PVRs. Thus, unless otherwise stated, the use of the term DVR is meant to include a PVR.

As with any file-oriented digital storage technology, when recording a program using a DVR device, it is necessary to store both the program content (the video program) and an index entry identifying the location and other characteristics about the program content so that it can be subsequently retrieved and played back. In a manner much like a personal computer, DVRs maintain a directory or “catalog” of all of the recordings (files) stored on disk. This directory may also contain additional information about the program content such as the air date/time, channel, network, program title, summary information, length, etc. Such additional information is used to make it easier for the user to “browse” through stored video content.

FIG. 1 is a block diagram of a typical prior-art system 100 for digital video recording, sometimes referred to as a personal video recorder (PVR) system. The system 100 comprises a digital video recorder device 110 connected to a communications network or medium 170 whereby the digital video recorder device 110 can access external services 180 and/or remote storage 190. These remote services 180 and storage 190 are usually made available on a subscription basis for the purpose of providing Electronic Program Guide (EPG) functionality, automatic firmware update capability, pay-per-view (PPV), video-on-demand (VOD), etc. On some systems, the communications network 170 shares the same transmission medium as a video source. For example, on many cable television systems, video transmission and communications are both provided via a single cable hookup. In other systems, the communications network 170 is provided via a separate, independent medium such as a dial-up telephone network or the Internet.

The digital video recorder device 110 comprises a receiver 120, a controller 130, a primary storage medium 140, non-volatile memory (NVM) 150 and a communications link 160. The receiver 120 receives video transmissions (e.g., via cable, satellite, airwaves, etc.) and converts them into a digital video stream that can be displayed, recorded, etc. The controller 130 is the “brain” of the digital video recorder system and performs most of the major functions of the digital video recorder device 110, such as descrambling and/or decoding video streams, storing/retrieving digital video to/from the primary storage medium 140, maintaining configuration information and firmware in non-volatile memory (NVM) 150, providing video playback, providing user interface functions, and communicating via the communications link 160 to provide such functionality as EPG, VOD, PPV and automatic firmware updates. Typically, the controller 130 is a microprocessor that operates according to a set of instructions stored within the DVR device. The primary storage medium 140 is typically a hard disk drive on which digital video recordings are stored. A catalog or index of those digital video recordings is maintained on the primary storage medium 140 as well.

In normal usage, a user will use the digital video recorder device 110 to access and browse an electronic program guide (EPG). The user then identifies one or more programs listed in the EPG to be scheduled for recording. At the appropriate time, the controller 130 commands the receiver 120 to tune to the user-identified program and records the program to the primary storage medium 140. On many systems, the user can specify a compression level for recording whereby the quality of the recording can be traded off against the amount of storage required for the recording.

One problem with DVRs (and with most other recording technologies) is that a variety of “disturbances” can occur that interrupt recording. Some examples are: power failures, primary storage device failure (HDD failure), remotely initiated firmware updates (i.e., upgrades/updates to DVR firmware initiated by a service provider), loss of video signal (LOS) and Emergency Alerts (e.g., Emergency Broadcast System (EBS) tests, or weather/emergency broadcasts). Since these disturbances can occur without warning and prevent further recording of the desired program or service for their duration, they can have a significant impact on scheduled recording activity. For example, if a power failure occurs during a recording, at least the remainder of the recording is lost.

Another “disturbance” that can affect scheduled recording is insufficient storage space on the primary storage medium (e.g., HDD). When no storage space remains, further recording is not possible.

In light of the foregoing, it would be desirable to provide a mechanism by which a DVR could detect and recover from the aforementioned and other disturbances.

### SUMMARY OF THE INVENTION

The present inventive technique overcomes the problems cited above by maintaining a journal of DVR operations (recordings, interruptions, etc.) and maintaining a backup copy of a catalog for the primary storage device. The journal and the backup catalog are preferably stored in non-volatile memory within the DVR or on a separate device, such as an external disk drive, external semiconductor memory (e.g., flash card) or remote, network connected storage device. When a “disturbance” interrupts recording, the DVR examines the journal and the catalog to determine what actions to take.

A variety of “disturbances” or interruptions can interrupt video recording. These disturbances include: power failures, remotely initiated firmware updates, primary storage device failure, Emergency Alert broadcasts and loss of signal (LOS).

According to an aspect of the invention, when such a disturbance is detected by a digital video recorder (e.g., PVR), it waits until the end of the disturbance and determines a duration for the interruption caused by the disturbance. If the video program that was being recorded when the disturbance occurred is still running, then recording is resumed. If the duration of the interruption is greater than a pre-determined threshold value (which can be user-specified), the digital video recorder (DVR) determines if the video program will be available for recording at a later time (e.g., by searching an Electronic Program Guide (EPG). If the video program is available for later recording, it is rescheduled for recording at that time.

Another condition that can disturb normal DVR operation is insufficient primary storage space. If the DVR detects that insufficient primary storage device space is available for all scheduled recordings, it can do one of three things: 1) make all scheduled recordings at a lower bit rate (higher compression ratio) thereby requiring less primary storage space; or 2) free up primary storage space by deleting recordings that can be recovered at a later time; or 3) re-encode existing content at a lower bit rate, possibly using a different encoding scheme (e.g., re-encoding MPEG-2 to MPEG-4).

According to an aspect of the invention, the DVR can provide for recovery of deleted recordings by selecting only those recordings for deletion that will be available for re-recording at a later time (e.g., re-broadcast at a later time when the DVR can re-record them).

According to another aspect of the invention, the DVR usually detects that there is insufficient primary storage space before scheduled recording begins. It can delete one or more recordings from the primary storage medium, providing for their later recovery by archiving them to a secondary (e.g., remote) storage medium prior to deleting them. Since there is usually advance warning, the deleted programs can be archived (prior to deletion) via relatively slow storage media such as remote storage devices located on the Internet or on a LAN to which the DVR is connected. Alternatively, a secondary storage device can be connected directly to the DVR via a suitable interface (e.g., USB, Firewire, SCSI, etc.).

In one preferred embodiment of the present invention, the DVR performs the various functions and method steps described herein above by means of a set of stored instructions adapted to cause the DVR's controller (typically a microprocessor device) to perform those functions and method steps.

### BRIEF DESCRIPTION OF THE DRAWINGS

These and further features of the present invention will be apparent with reference to the following description and drawing, wherein:

FIG. 1 is a block diagram of a typical prior-art PVR (personal video recorder) system.

FIG. 2 is a flowchart of a method of recovering from disruption of video recording due to an external source, in accordance with the invention.

FIG. 3 is a flowchart of a method of recovering from a shortage of space on a primary storage medium during video recoding, in accordance with the invention.

### DETAILED DESCRIPTION OF THE INVENTION

The present inventive technique deals with interruptions to recording (e.g., on a DVR) by means of a journaling system. A record of the journaled information is kept in non-volatile memory (NVM). In this way, if the video recorder is reset (e.g., power failure or remote firmware update), there is a record in NVM of what the recorder was doing when it was interrupted and at what point it was interrupted. Based on the stored “journal,” the recorder can determine what course of corrective action to take. Further, the recorder keeps a “backup copy” of the catalog (HDD directory or index) in secondary storage. This secondary storage can be provided by NVM or on another storage medium (e.g., a disk drive on a LAN to which the recorder is connected, or on a remote network storage device such as an Internet-connected file server).

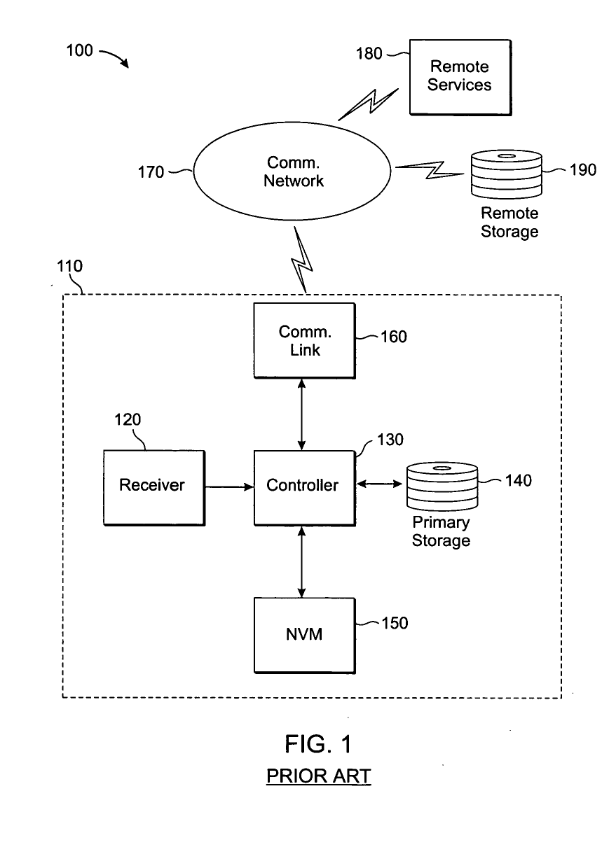

As described hereinabove with respect to FIG. 1, a DVR typically includes a “controller” (see 130, FIG. 1), which executes a set of instructions stored within the DVR. Those instructions control how the DVR behaves, including what conditions the DVR will respond to, and what actions it will take in response to those conditions.

A DVR catalog is essentially a directory of the recordings stored on the DVRs primary storage medium. Other information about the recordings may be stored in the catalog, such as program air date/time, channel, title, genre, summary information, etc. Typically, a catalog is very small (compared to video recordings) and is accessed or modified infrequently.

The backup copy of the catalog is preferably maintained on a storage medium other than the primary storage medium. In this way, if the primary storage medium fails, there is a record of what was recorded. Because the catalog is much smaller than the content, it can be easily stored in less vulnerable locations, such as in internal non-volatile memory or on an external storage medium. If the failure of the storage medium is simply a failure of a single HDD sector, then the catalog can be used to identify what program is affected. If the program will be re-broadcast at some time in the future, the DVR can automatically schedule the program for re-recording at that time. In the event of complete failure of a HDD (or, e.g., upgrade of a HDD to a larger size), the DVR can use the catalog in combination with an EPG to attempt to re-populate the replacement HDD. Although it may not be possible to recover all of the “lost” recordings, over time it should be possible to recover many of them (as they are subsequently re-broadcast). The DVR could also access the Internet to re-populate specific recordings, but this may require payment of fees or acquiring specific authorization (due to Digital Rights Management (DRM) issues).

Assuming a catastrophic (unrecoverable) failure of the Primary Storage Device and that there is an external storage medium or a connection (e.g., wireless) to an external storage medium, the DVR software searches EPG listings for the same program (typically available as a part of a subscription service), informs the user of the Primary Storage Device failure and offers the option to catalog and store lost programs and/or any other scheduled recordings on an external storage medium. To accomplish this, the DVR software accesses the backup copy of the catalog (in NVM or external storage).

In the event of a power failure, the DVR software would examine the saved journal to determine when the power failure occurred, and compare with the current time to determine the duration of lost programming. If the interruption is less than a predetermined threshold duration (this can be a user configurable setting), the recording would be resumed. If the interruption is greater than the threshold duration, the DVR software would search the EPG listings for the same program, inform the user of the power failure and offer the option to record the program at another time (this can also be a user configurable setting that would initiate an automatic recording once a matching program is found). As in the case of a Primary Storage Device failure, this functionality assumes that a valid backup copy of the catalog is available to the software.

In the event of a remotely initiated firmware upgrade (that forces the DVR to reset itself), the resultant interruption (disturbance) is handled in exactly the same way as a power failure. From a user's perspective, a firmware upgrade causes the same disruption to the DVR recording as a power failure.

Another type of failure that can occur is an interruption within the broadcast video itself. Two examples are temporary loss of signal (LOS), and Emergency Alert messages. LOS occurs when the video provider (cable provider, satellite provider, television station, etc.) has a temporary failure that interrupts the video signal. An LOS condition may last seconds, minutes, or even hours. Since the video stream is lost, recording is not possible during an LOS condition.

Although not, strictly speaking, LOS conditions; Emergency Alerts have the same effect on recording as LOS. An Emergency Alert is a program interruption to notify viewers of a Weather emergency (e.g., hurricane, tornado, hailstorm) or a civil emergency (e.g., fire, explosion, major accident). These alerts force the video stream (on any channel) to a special alert channel, and can last anywhere from a minute or two to much longer, depending upon the severity of the emergency. In addition, the Emergency Broadcast System (EBS) is frequently tested, forcing all channels to the test program for the duration of the test. Upon detecting such an interruption, the DVR should handle recording in a manner similar to that employed for power failures. The difference is that the LOS conditions and Emergency Alerts do not “reset” the DVR. In such cases the DVR should pause recording during the interruption, detect the end of the interruption, then proceed as if the power had failed. Alternatively, the DVR can continue recording during the interruption and overwrite the recording made during the interruption when the interruption is over. If the interruption was short (less than the pre-determined threshold duration), the recording is simply resumed. If the interruption is longer, either the user is offered the option of re-recording later or re-recording is automatically scheduled (depending upon DVR configuration settings and availability of the program at a later time).

The predetermined threshold duration differentiates between short-term, minor “blips” in the recording and long gaps. By definition, anything shorter than the threshold duration is a minor disturbance, and recording is simply resumed on the assumption that the relatively short interruption will be inoffensive. Longer gaps, i.e., interruptions longer than the threshold duration are considered to be major disruptions that may require more extensive recovery measures. It is possible that in some applications, all gaps will be considered offensive. In such cases, the threshold duration can be either presumed to be equal to zero, or can be explicitly set to zero, in which case the DVR treats all interruptions, however short, in the same way as described herein for longer gaps.

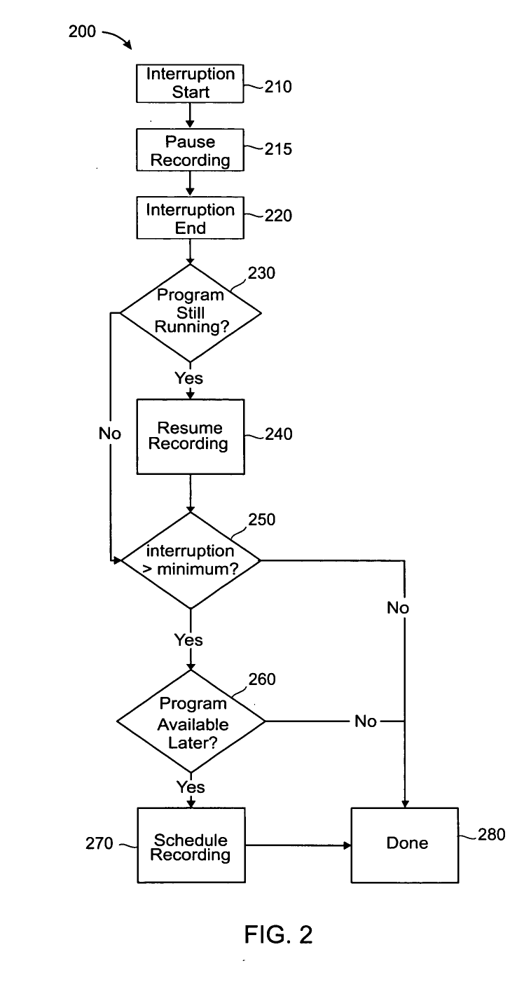

FIG. 2 is a flowchart 200 of a preferred technique for recovering from an interruption to digital video recording due to an unpredictable event such as power failure, remote firmware update, failure of the primary storage medium or a program interruption such as an emergency broadcast system (EBS) test. In a first step 210, an interruption occurs (e.g., power fails, firmware update begins, hard disk fails, emergency broadcast system test starts, etc.). In a next step 215, recording is paused. Until the interruption ends, further meaningful recording is not possible. In a next step 220, the end of the interruption is detected (e.g., power is restored, firmware update ends, hard disk drive is repaired/replaced, emergency broadcast system test ends, etc.). Some interruptions are brief and only affect a small portion of the program being recorded. Others are longer, preventing recording of a significant portion of the program. After the interruption ends (e.g., when the digital video recorder powers up again after a power failure or return of normal programming after a loss-of-signal or EBS test), a next step 230 determines whether the program that was being recorded at the time of the interruption is still running. If it is still running, recording is resumed in a next step 240 and is run to completion. A next step 250 determines whether the interruption was longer in duration than a preset minimum. If not, then recovery from the interruption is complete (step 280). If the interruption was longer in duration than the preset minimum, a next step 260 accesses the EPG to determine whether the program being recorded is available again at some time in the future. If it is, a next step 270 schedules the next broadcast of the program for re-recording, and the recovery process is completed (step 280). If not, the recovery process is completed (step 280) without scheduling a replacement recording.

Those of ordinary skill in the art will immediately understand that some adaptations and/or rearrangement of the order of processing is possible while still achieving substantially the same result. For example, rather than pausing recording during an interruption, recording could be continued. After the interruption, any new recording could be arranged to overwrite anything recorded while the interruption was in progress. By was of further example, recording could be resumed either prior to or after the test in step 230, with appropriate adaptations to stop recording if the program is no longer running. These and other similar adaptations are fully within the spirit and scope of the present inventive technique.

Another type of failure that can occur is when the DVR software predicts that a program will require more storage space than is currently available on the Primary Storage Device. There are several techniques available to address this scenario. One technique is to record at a lower bit rate (i.e., increased video compression ratio), thereby conserving space on the primary storage device at the expense of video quality. A second technique is to free up primary storage device space by archiving (backing up) previously recorded material to an external storage medium (e.g., to a storage device on a local area network (LAN) to which the DVR is connected, or to a remote storage device such as an Internet-connected file server), and then deleting the now archived material from the primary storage medium prior to the scheduled recording time. Because there is usually advance warning of the storage space problem, archiving can be done via lower speed, less reliable mechanisms such as, for example, FTP (file transfer protocol) over 802.11a/b/g (IEEE standards for wireless networking). A third technique is to search the EPG listings (and any other suitable information resources) for recorded programs that will be rebroadcast at a later time. Any such programs can be deleted from the primary storage medium and re-recorded later. A fourth technique is to re-encode existing content at a lower bit rate, possibly using a different encoding scheme (e.g., re-encoding MPEG-2 to MPEG-4), thereby freeing up primary storage space for new recordings.

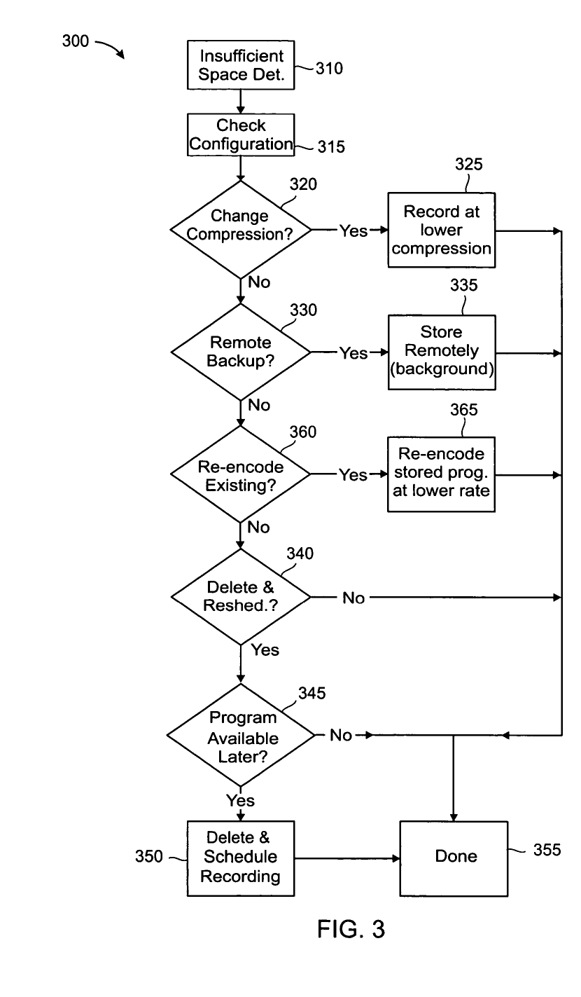

FIG. 3 is a flowchart 300 of a technique for recovering from a shortage of space on the primary storage medium during video recording in the manner described hereinabove. In a first step 310, the space shortage is detected. In a next step 315, the controller checks the configuration settings for the digital video recorder (DVR). A next step 320 determines whether the DVR is configured to change the recording compression ratio to conserve storage space. If so, the compression setting is altered for the recording to increase the compression level and to reduce the amount of disk space required in a next step 325, after which the recovery process completes (355).

If the compression is not to be changed at step 320, a next step 330 determines whether a remote backup function is configured. If so, a next step 335 frees up space on the primary storage device by backing up one or more previously recorded programs to a remote storage device (such as an external hard drive on a local area network (LAN) or a remote storage device on the Internet). As previously recorded programs are backed up, they can be deleted from the primary storage device, thereby freeing up space while still retaining the option of retrieving them again later. The recovery process is then complete, as indicated at step (355).

In the event a remote backup is not provided at step 330, a next step 360 determined if the DVR is configured to free up storage space by re-encoding existing stored program content at a lower bit rate. If so, a next step 365 re-encodes existing program content accordingly to free up primary storage space, e.g., by re-encoding at a higher compression ratio or by “transcoding” stored program content by a different encoding scheme that uses less primary storage space (e.g., re-encoding MPEG-2 content into MPEG-4 content). If the DVR is not configured to re-encode existing program content, a next step 340 determines if the DVR is configured to free up primary storage space by deleting and rescheduling recording of other programs. If so, a next step 345 accesses the EPG to determine if any previously recorded programs are available for recording at a later time. If so, a next step 350 deletes the previously recorded program and reschedules it for recording at a later time, thereby freeing up space on the primary storage medium to record new material without losing the opportunity to re-record and view the deleted material. The recovery process then completes (step 355).

Although shown and described as independent options, those of ordinary skill in the art will understand that the recovery mechanisms shown and described with respect to FIG. 3 (higher compression (325), remote archiving (335), delete and reschedule (350)), re-encoding at lower bit rate (360) can be used in combination to free up even greater amounts of primary storage space. Moreover, the options provided can be done in different orders than the order shown in the flowchart of FIG. 3, which only illustrates an example implementation.

Remote storage can be accomplished by one or more of a variety of mechanisms. One mechanism is to provide a separate, external HDD to the DVR via any suitable interface (e.g., USB, Firewire, PC Card Interface, SCSI bus, dedicated ATAPI connection, etc.). Another mechanism is to connect the DVR to a user's local area network that provides access to a disk drive on the network (e.g., a drive on a user's computer or a dedicated network storage device). Another mechanism is to provide remote Internet storage via an Internet-connected file server.

Typically, the method steps described hereinabove with respect to FIGS. 2 and 3 are performed by the DVR's controller (see 130, FIG. 1—typically a microprocessor device) operating according to a predefined set of instructions adapted to cause the controller to execute those method steps. This predefined set of instructions can be stored locally (within the DVR) in nonvolatile storage, or can be retrieved from an external or remote storage device for execution by the controller.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A method of recovering from a disturbance to digital video recording, comprising:
detecting the occurrence of a disturbance to digital video recording of a video program;
determining that the disturbance has ended and determining a duration thereof;
determining if the video program is still running and if so, resuming recording;
if the duration of the interruption is greater than a pre-determined threshold value, performing the additional step of:
determining if the video program will be available for recording at a later time and if so, re-scheduling recording of the video program for the later time.

2. A method according to claim 1, further comprising:
maintaining a journal of digital video recorder (DVR) operations.

3. A method according to claim 1, further comprising:
maintaining a backup copy of a catalog of recorded programs in secondary storage.

4. A method according to claim 3, wherein:
the secondary storage is non-volatile memory.

5. A method according to claim 3, wherein:
the secondary storage is a remote storage device.

6. A method according to claim 1, wherein:
the predetermined threshold value is user-specified.

7. A method according to claim 1, wherein:
the disturbance is a power failure.

8. A method according to claim 1, wherein:
the disturbance is a remotely initiated firmware update.

9. A method according to claim 1, wherein:
the disturbance is a primary storage device failure.

10. A method according to claim 1, wherein:
the disturbance is an Emergency Alert broadcast.

11. A method according to claim 1, wherein:
the disturbance is a loss of signal (LOS) condition.

12. A method according to claim 1, wherein:
the step of determining if the video program will be available at a later time is accomplished via Electronic Program Guide functionality.

13. A method for recovering from a condition whereby insufficient primary storage space exists for a scheduled digital recording, comprising:
determining that insufficient primary storage space exists to store the scheduled recording; and
changing a compression ratio setting for the scheduled digital recording such that the recording will require less primary storage space.

14. A method for recovering from a condition whereby insufficient primary storage space exists for a scheduled digital recording on a digital video recorder, comprising:
determining that insufficient primary storage space exists to store the recording; and
freeing up primary storage space occupied by one or more previously recorded programs;
performing the scheduled recording using the freed up primary storage space.

15. A method according to claim 14, wherein:
primary storage space is freed by deleting one or more previously recorded programs.

16. A method according to claim 15, further comprising:
rescheduling one or more of the deleted programs for recovery at a later date.

17. A method according to claim 14, wherein:
primary storage space is freed by re-encoding one or more previously stored programs to occupy less primary storage space.

18. A method according to claim 17, wherein:
primary storage space is freed by re-encoding one or more previously stored programs at a higher compression ratio.

19. A method according to claim 17, wherein:
primary storage space is freed by re-encoding one or more previously stored programs by means of a different encoding scheme that requires less primary storage space.

20. A method according to claim 14, wherein:
the step of providing for recovery of the one or more deleted programs further comprises:
saving the deleted programs to a remote storage device.

21. A method according to claim 15, wherein:
the remote storage device is a storage device on a local area network (LAN) to which the digital recorder is connected.

22. A method according to claim 15, wherein:
the remote storage device is an Internet-connected remote storage device.

23. A method according to claim 15, wherein:
the remote storage device is an auxiliary storage device connected directly to the digital video recorder.

24. A method according to claim 14 wherein:
the step of providing for recovery of the one or more deleted programs further comprises the steps of:
identifying one or more programs for deletion by searching an electronic program guide (EPG) for previously recorded programs that will be available for recording at a later time; and
scheduling the identified programs for re-recording at the later time.

25. A DVR device with recovery capability, comprising:
means for detecting a disturbance to digital video recording of a video program;
means for determining a duration for the disturbance;
means for resuming recording of the video program if it is still running when the disturbance ends;
means for determining if the duration of the interruption is greater than a pre-determined threshold value;
means for determining if the video program will be available for recording at a later time; and
means for recording of the video program at the later time if said threshold value is exceeded and if the program is available at said later time.

26. A device according to claim 25, wherein a journal of digital video recorder (DVR) operations is maintained.

27. A device according to claim 25, wherein a backup copy of a catalog of recorded programs is maintained in secondary storage.

28. A device according to claim 25, wherein:
the disturbance is a power failure.

29. A device according to claim 25, wherein:
the disturbance is a remotely initiated firmware update.

30. A device according to claim 25, wherein:
the disturbance is a primary storage device failure.

31. A device according to claim 25, wherein:
the disturbance is an Emergency Alert broadcast.

32. A device according to claim 25, wherein:
the interruption is a loss of signal (LOS) condition.

33. A device according to claim 25, wherein:
the means for determining if the video program will be available at a later time employs Electronic Program Guide (EPG) functionality.

34. A DVR with recovery capability, comprising:
means for determining that insufficient primary storage space exists to store a digital recording; and
means for changing a compression ratio setting for the digital recording such that the recording will require less primary storage space.

35. A DVR system, comprising:
a DVR device having a primary storage device;
a remote storage device;
a network connection to the remote storage device;
means for determining that insufficient primary storage space exists to store a recording;
means for freeing up primary storage space by deleting one or more previously recorded programs;
means for recovering the one or more deleted programs at a later date; and
means for recording using the freed up primary storage space.

36. A system according to claim 35, comprising:
means for storing a program deleted from said primary storage device on said remote storage device.

37. A system according to claim 36, wherein:
the remote storage device is one of an Internet-connected or LAN-connected remote storage device.

38. A system according to claim 35, further comprising:
means for identifying one or more programs for deletion by searching an electronic program guide (EPG) for previously recorded programs that will be available for recording at a later time; and
means for re-recording the one or more identified programs at the later time.
